(19) United States
(12) Patent Application Publication
(10) Pub. No.: US 2010/0299619 A1
(43) Pub. Date: Nov. 25, 2010

(54) Model for Reusable User Interface and Logic for Software Wizards

(75) Inventors: Jonathan Marshall Rowlett, Redmond, WA (US); Yonghua Wei, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/468,872

(22) Filed: May 20, 2009

(51) Int. Cl. G06F 3/00; G06F 9/44

(52) U.S. Cl. 715/760; 717/107

(57) ABSTRACT

Described is a reusable software wizard component that is invoked to integrate its elements (e.g., logic, pages, data and/or tasks) with elements of a wizard to provide an integrated wizard. For example, the integrated wizard may provide customized wizard functionality yet be efficiently developed by the use of at least some re-useable elements. In one implementation, the reusable software wizard component corresponds to a class having interfaces/functions for getting its data, pages and/or tasks. The selected pages and/or tasks may be integrated with pages and tasks of the wizard in any suitable order. Pages from the reusable software wizard component may be pre-filled with data from the wizard.

### BACKGROUND

A software wizard is a series of user interface dialog pages or the like with which users interact to enter information. Depending on the user's interaction and/or entered information, the wizard dialogs generally collect the information needed to perform some task, such as to configure network settings.

There has been a desire for software product suppliers such as an original equipment manufacturer (OEM) or independent software vendor (ISV) to modify existing wizards in some way, such as to add more steps or skip some steps so as to make the wizard more appropriate for a product. However, there is no straightforward way to extend logic in the context of a user interface wizard. In general, this is only able to be done by re-implementing significant functionality, that is, by basically creating a new wizard.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a reusable software wizard component may be invoked to integrate elements thereof (e.g., logic, pages, data and/or tasks) with elements of a wizard to provide an integrated wizard. For example, the integrated wizard may use as much of the reusable software wizard component's elements as desired, yet also provide custom elements, to provide customized wizard functionality with the benefit of some re-useable elements.

In one aspect, the reusable software wizard component comprises an instance of a class that includes an interface and function for getting any or all of the data, pages and/or tasks from the reusable software wizard component. In other aspects, the pages and/or tasks may be integrated with pages and tasks of the wizard in any suitable order. In the integrated wizard, the pages from the reusable software wizard component may be pre-filled with data from the wizard. Dependency constraints may be specified as to how the data of the reusable software wizard component may be used by any task and/or page in the integrated software wizard.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for integrating a wizard wand component with an existing wizard to produce an integrated wizard.

FIG. 2 is a representation of a third party (e.g., OEM) wizard that has been integrated with a wizard wand component.

FIGS. 3A and 3B comprise a sequence diagram describing how a framework coordinates elements of a wizard control with elements of a wizard wand component.

FIG. 4 is a representation of a wizard wand base class and example classes and interfaces associated therewith.

FIG. 5 shows an illustrative example of a computing environment into which various aspects of the present invention may be incorporated.

### DETAILED DESCRIPTION

Various aspects of the technology described herein are generally directed towards providing a reusable wizard component (e.g., with elements comprising pages, data, logic and task information) that can be integrated with other (e.g., custom) wizard elements into an integrated wizard, thereby supporting wizard pages and wizard logic in a reusable manner. As will be understood, the technology allows developers (e.g., of an OEM or ISV, hereinafter interchangeably used with “third party” regardless of the actual relationship with the provider of the reusable wizard components) to integrate their own user interface pages, data, and tasks into an integrated wizard experience. The third-party developer has ultimate control of what the integrated wizard actually displays and performs.

In one implementation, this is accomplished in part by a component abstraction, referred to herein as a “wizard wand component” (or simply “wizard wand”) that encapsulates pages, data and/or task information into a reusable component, and generally provides re-useable logic that governs how pages are tied to data and tasks. Further, a wizard wand framework includes common functionalities that make a web-based wizard extendable. Thus, a wizard wand is a reusable and extensible wizard-related component that may contain pages, data, and/or tasks (e.g., data query tasks), as well as other concepts (described below) including summary text nodes and/or commit tasks. Note that a wizard wand component is integrated with an existing wizard in a way that does not compromise the integrity of the logic of the wizard wand component.

While some of the examples herein are generally directed to an example architecture and design for a wizard wand/framework in a web-based user interface, it is understood that this is only an example. For example, wizard wand technology may apply to integrated wizards used by non-web applications, or other components, data and/or settings that are independent of web interfaces. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and user interface elements in general.

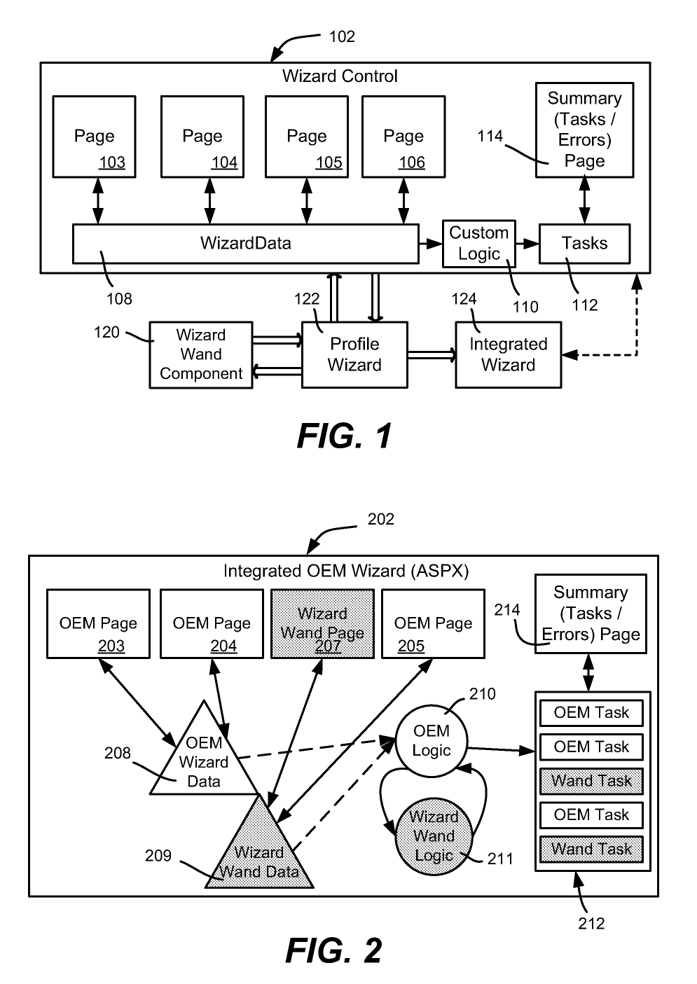

By way of example, FIG. 1 shows how a third party such as an OEM may provide various data including transitional content for the body of a page that is part of an initial configuration wizard. The OEM provides a single ASPX file that contains a wizard control 102. The wizard control 102 references any number of pages such as implemented in ASCX files (e.g., 103-106). Each such file updates a shared WizardData element 108. At the end of the wizard, custom logic 110 creates a sequence of tasks 112 to run that are based on the WizardData element 108 to complete the wizard. A summary task/errors page 114 may provide progress, status and other information.

FIG. 1 also shows a wizard wand component 120 that may be called (e.g., by a tool such as a profile wizard 122) to integrate reusable wizard pages and/or wizard logic into the flow of the wizard control 102, thereby providing an integrated wizard 124. To this end, in one implementation, the profile wizard 122 can invoke the wizard wand component 120 and thereby create and control other elements (e.g., pages, logic and tasks) that can be integrated into the integrated wizard 124. Note that instead of the exemplified implementation of FIG. 1 in which the profile wizard 122 creates the integrated wizard 124 as a separate entity, the profile wizard 122 may directly modify the wizard control 102 with elements from the wizard wand component 120 (or if desired, from multiple wizard wand components); that is, the wizard control 102 is modified to become the final, integrated wizard.

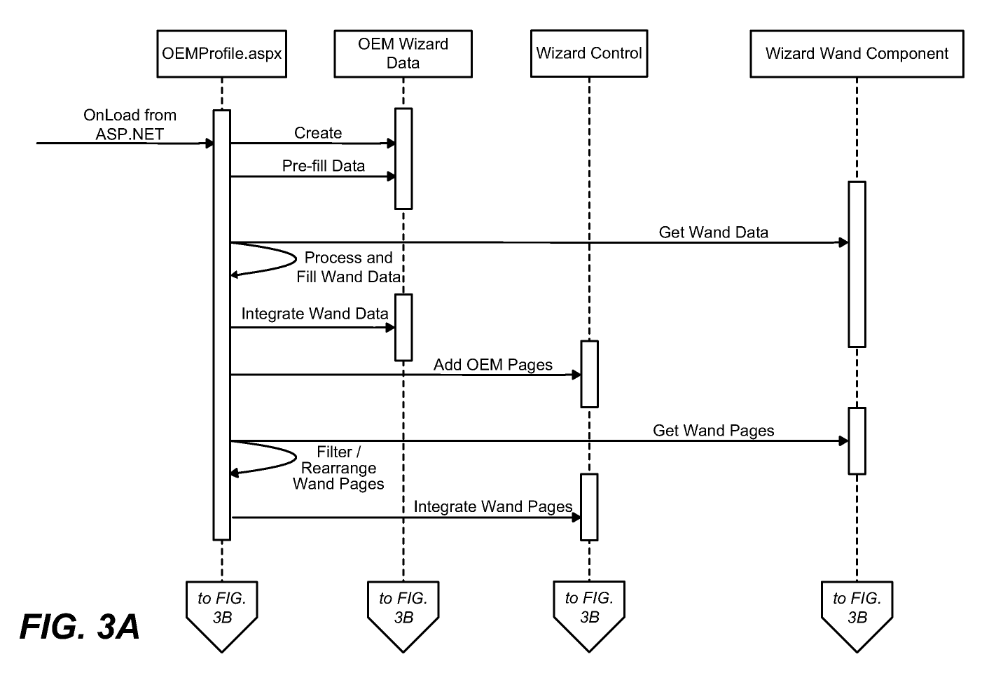

FIG. 2 represents an example integrated third party (e.g., OEM) wizard after it has been integrated with a wizard wand (with wizard wand elements shown in shaded form). As can be seen in this example, OEM pages 203-205 are combined with a wizard wand page 207. Note that while only one wizard wand page is shown in this example, multiple such pages may be integrated, and the various overall pages may be ordered in any appropriate way.

The OEM wizard data 208 and wizard wand data 209 may be accessed by any page. Further, OEM logic 210 may work in conjunction with wizard wand logic to generate the tasks 212; the tasks 212 may contain a combination of OEM tasks and wizard wand tasks, in any appropriate order. A summary task/errors errors page 214 is also provided, such as to show what tasks will commit in what order, and with what data.

By way of example, consider a wizard that configures some settings for a product. Much of the data and functionality may be provided in a wizard wand component that is generic to many such products, however some may not apply. For example, it is not appropriate to ask a user to select among operating modes when a particular product can only operate in one mode. A third party that provides the product thus may use some of the pages from the generic wizard wand component, but not all, choosing instead to provide customized pages that are more appropriate for this particular product, and/or pre-filling any data that are not user configurable with this particular product/version. The third party may also include logic that performs a proprietary task instead of the non-proprietary task that the wand provides.

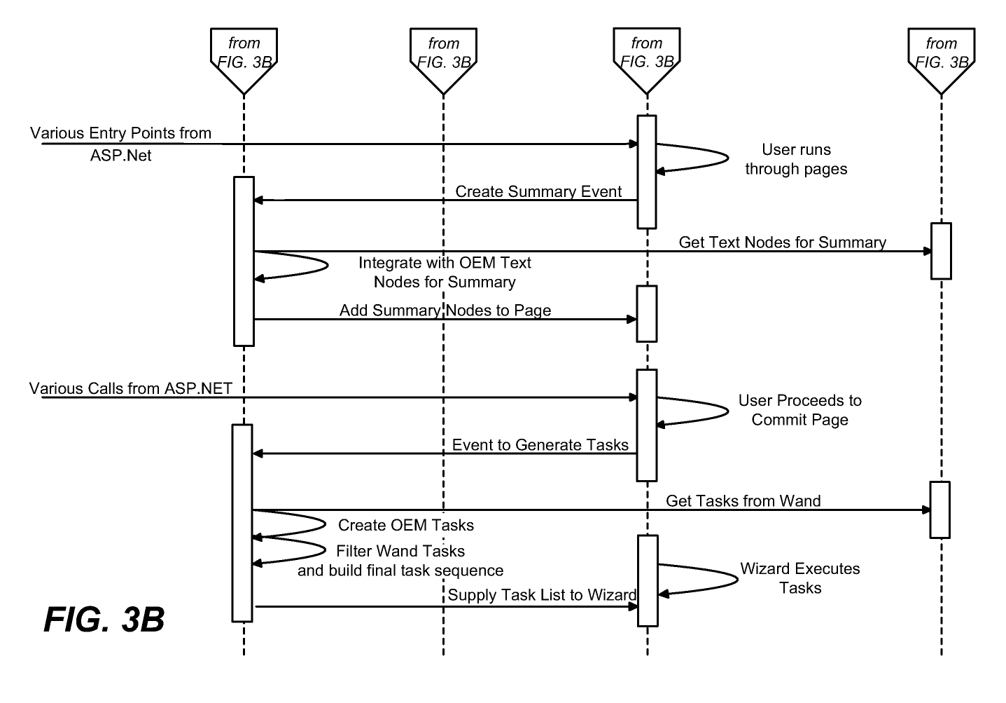

FIGS. 3A and 3B comprise a sequence diagram describing how the OEM Profile Wizard coordinates with a wizard wand throughout its run. In general, the flow includes creating the OEM wizard data element and filling it as desired.

When building the overall flow, the wizard wand component 120 can be called to determine whether or not certain pages from the wizard wand component 120 are to be in the sequence, based on its wizard data (Get Wand Data). Such wand data may be integrated. OEM pages may be added, as may wand pages once retrieved (Get Wand Pages); they may be filtered and rearranged as part of their integration.

Because the OEM wizard is providing input components and consuming output components from the wizard wand, the OEM wizard has the opportunity to provide default values for input and filter output. For example, an OEM wizard may pre-fill data for a wizard wand and skip a few pages of that wizard wand as a result. The wizard can also decide to chain the wand's pages differently, or add their own pages in between at runtime. The existing pages can be reused as-is, however OEMs may control aspects of what the pages do by pre-filling data.

As represented in FIG. 3B, when the OEM Profile wizard needs to build the sequence of tasks based on the wizard data, it can call the wand (or wands) that it is using to get the set of tasks needed to run for each wand. The OEM wizard can also insert its own tasks between tasks returned by the wizard wand. Note that summaries and text nodes are described below.

As can be seen, the wizard wand component 120 thus facilitates the integration of pages, as well as the data behind the pages and the tasks that need to execute as a result of those pages. Significant aspects to wizard wands include that they are reusable components, and that a wizard can use multiple wands. One solution allows a third party to use data from their own third-party pages as well as data from existing pages. Moreover, a third party can provide information for tasks that need to be run, and can insert their own tasks into a list of tasks that run at the end of the wizard.

Pages and tasks may declare their dependency on specific data elements; a page may not be valid unless a user has made a certain selection. This can be used to help the designer decide whether to show a page based on its prerequisites. Also, the designer can pre-fill the data to specify whether a page is needed. In addition, the designer can decide whether to show a task and/or supply the parameters for a task without requiring user input.

Other aspects include that wizard wands may be combined in any useful way. For example, a developer may put together a meta-driven/automated way to put a wizard and multiple wands together to provide a more complex experience, such as to provide a more end-to-end user experience.

### Example Implementation

In one implementation, a wizard wand may comprise a .NET component that supports a standard interface that is defined for retrieving wizard pages and asynchronous tasks at different stages of the wizard. Further, data can be supplied or consumed through this interface. Whenever data is updated, the wand determines which pages and tasks are valid and generates a summary of the tasks to be performed. Each page and task is uniquely identified, which allows OEMs to identify these pages, tasks, and data at runtime.

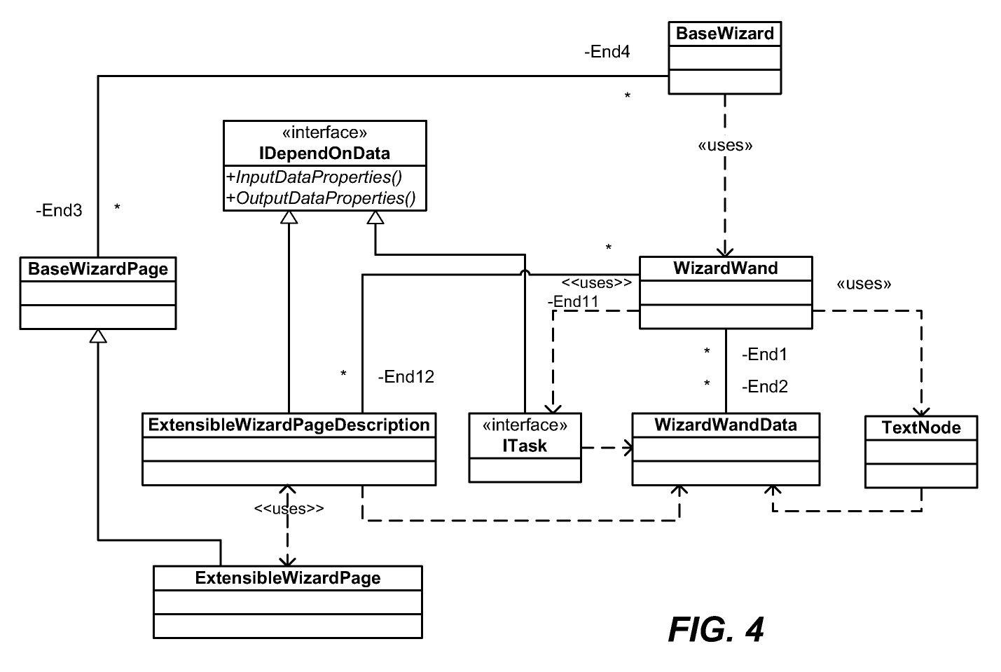

As shown in FIG. 4, in one implementation, Class WizardWand is the base class from which a wizard wand class derives. The derived class overrides the protected virtual methods in WizardWand. The output of those protected virtual methods is validated by the framework to enforce certain constraints on the derived class.

```
  public abstract class WizardWand : Component
  {
    protected WizardWand( );
    public ReadOnlyCollection<ExtensibleWizardPageDescription>
AllWizardPages { get; protected set; }
    public WizardWandData Data { get; protected set; }
    protected ReadOnlyCollection<ITask> DataCommitTasks { get; set; }
    protected ReadOnlyCollection<ITask> DataQueryTasks { get; set; }
    public ReadOnlyCollection<ExtensibleWizardPageDescription>
ShownWizardPages { get; protected set; }
    protected ReadOnlyCollection<TextNode> SummaryTree { get; set; }
    public ReadOnlyCollection<ITask> GenerateDataCommitTasks( );
    public ReadOnlyCollection<TextNode> GenerateSummaryTextTree( );
    public ReadOnlyCollection<ITask> GetDataQueryTasks( );
    protected abstract ReadOnlyCollection<ITask>
OnGenerateDataCommitTasks(WizardWandData data);
    protected abstract ReadOnlyCollection<TextNode>
OnGenerateSummaryTextTree(WizardWandData data);
    protected abstract ReadOnlyCollection<ITask>
OnGetDataQueryTasks(WizardWandData data);
    protected abstract ReadOnlyCollection<ExtensibleWizardPageDescription>
OnUpdateShownWizardPages(ReadOnlyCollection<ExtensibleWizardPageDescription>
allWizardPages, WizardWandData data);
    public void UpdateShownWizardPages( );
  }
```

The data used by a wizard wand comprises a class instance derived from WizardWandData. As described above, the wizard wand operation is largely based upon the data, e.g., query tasks populate the data, input to wizard pages make changes to the data, the state of the data can trigger that different wizard pages be shown in a different order and/or appear differently, the text nodes of a summary page are generated from the data, and commit tasks attempt to commit the changes of data back.

In this implementation, each instance of class WizardWand has one (and only one) instance of WizardWandData, and each instance of class WizardWandData only belongs to one instance of class WizardWand. The WizardWandData instance of class WizardWand cannot be set after WizardWand is constructed. As a result, any complications from data sharing are avoided on the wizard wand framework level. If a derived class chooses to do so, data sharing can be accomplished across two wizard wand instances. For example, one property of data of two wizard wands may point to the same object.

The wizard wand is thus data driven, whereby there is not a direct dependency between components, other than any dependency between non-data components and the wizard wand data. By doing so, various components can be decoupled from each other and the wizard wand can achieve significant reusability.

public abstract class WizardWandData : Component
{
protected WizardWandData( );
}

Also shown as an interface in FIG. 4 is IDependOnData. Wizard pages and tasks provided by the wizard wand cannot be used freely by the user to create their own wizard. There are some constraints that need to be maintained about how to use the pages and tasks correctly, without which the development cost, test cost and service cost is likely to be high.

Thus, one constraint for a wizard page or a task from a wizard wand is that it has dependency on wizard wand data. A wizard page or a task may take several data properties as its input and output the results to several data properties.

ITask and ExtensibleWizardPageDescription implement an interface IDependOnData to declare their dependency on wizard wand data. By knowing the data dependency of various ITask and ExtensibleWizardPageDescription, third parties can figure out the implicit relationships among tasks and wizard pages, and third parties can take out certain tasks or wizard pages provided by the wizard wand and use their own logic to interact with the wizard wand directly by reading and writing directly from wizard wand data.

```
public interface IDependOnData
{
  PropertyDescriptorCollection InputDataProperties { get; }
  PropertyDescriptorCollection OutputDataProperties { get; }
}
```

Class ExtensibleWizardPage derived from BaseWizardPage to make the derive class to be aware of wizard wand. The class adds two properties, WizardWand of type WizardWand and Data of type WizardWandData. It also adds method void UpdateShownWizardPages( ) to refresh the shown page in the current wizard.

```
public abstract class ExtensibleWizardPage : BaseWizardPage
{
  protected ExtensibleWizardPage( );
  protected ExtensibleWizardPage(WizardPageType pageType);
  public WizardWandData Data { get; }
  public WizardWand ParentWizardWand { get; }
}
```

An ExtensibleWizardPageDescription instance is a description of an ExtensibleWizardPage instance. Because an ExtensibleWizardPage instance is a Web UI user control (ascx file and its logic), which has very short lifetime, an ExtensibleWizardPageDescription instance contains the information needed to load and reconstruct the ExtensibleWizardPage instance: ascx file name, virtual directory, wizard page title, wizard page ID, and its parent wizard wand.

Each WizardWand instance contains a read-only collection of ExtensibleWizardPageDescription instances as its available wizard pages. This collection of wizard pages cannot be changed after WizardWand instance is constructed and shown wizard pages are a subset of this collection. It is designed this way because the control tree of a wizard needs to be static to preserve states and events of the ASP.NET control the wizard contains.

It is the responsibility of wizard wand creator to make the ID globally unique. To make an ID globally unique, for example, the designer can either use a GUID or use the parent wand type name plus a unique ID inside the wand.

```
public class ExtensibleWizardPageDescription : IDependOnData
  {
    public ExtensibleWizardPageDescription(string ascxFileName, string
wizardPageTitle, string wizardPageID);
    public ExtensibleWizardPageDescription(string ascxFileName, string
wizardPageTitle, string wizardPageID, PropertyDescriptorCollection
inputDataProperties, PropertyDescriptorCollection outputDataProperties);
    public string AscxFileName { get; }
    public string ID { get; }
    public string WizardPageTitle { get; set; }
    public ExtensibleWizardPage LoadWizardPage(Page webPage);
  }
```

The TextNode class is designed to hold a line of text for the summary page of a wizard and it also contains a collection of children TextNode instances. According the current state of the data in the wizard wand, a list of TextNode instances can be generated.

```
public class TextNode
{
  public TextNode(string text);
  public IList<TextNode> Children { get; }
  [Localizable(true)]
  public string Text { get; set; }
}
```

Given a wizard wand, the following steps may be used to create a wizard:
(1) Create a welcome wizard page as the first page of the wizard. On this page normally the designer explains the functionality of this wizard. OnLeavePage—on this welcome page pops up a progress dialog. Add the data query tasks of this wizard wand to this progress dialog.
(2) Create a summary page, put a text box or a text tree control to display the summary text form the wizard wand.
(3) Create a commit page, put a CompletionPageStatus on the page, populate the commit tasks to the CompletionPageStatus control.
(4) Create a wizard class derived from BaseWizard. Include the welcome, summary and commit page to the wizard class.
(5) Override AddPages( ) of BaseWizard to add all pages in AllWizardPages property of the wizard wand.
(6) Override LinkPages( ) of BaseWizard, inside which the designer is to set the FirstPage property to the welcome page, and starting to link pages by setting the NextPage property of all pages in following sequence: welcome page, ShownWizardPages collection of the wizard wand, summary page and commit page.

### Exemplary Operating Environment

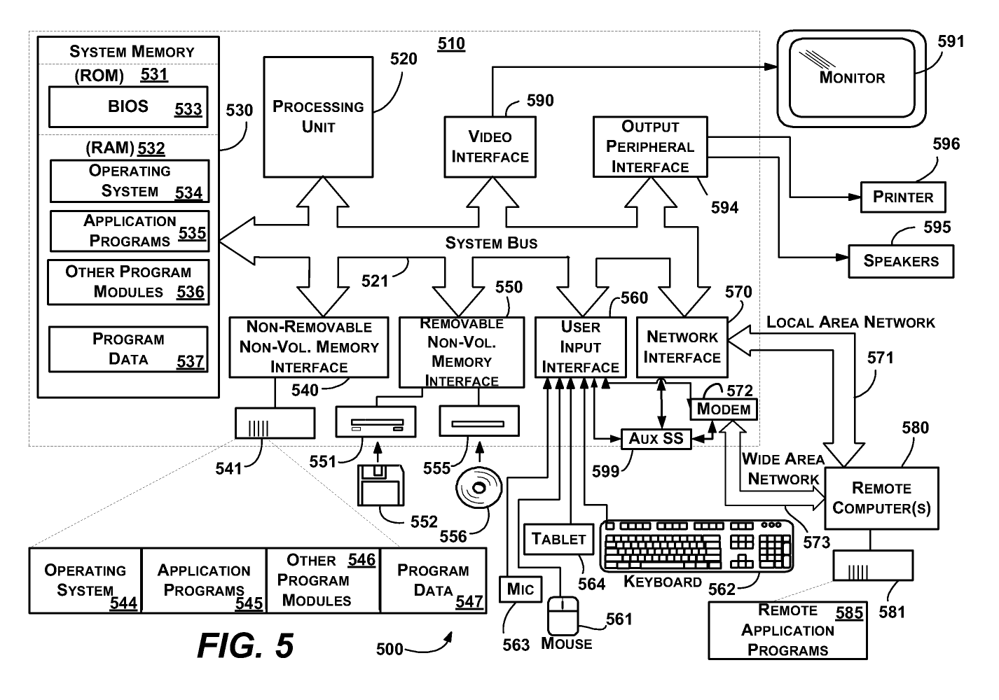

FIG. 5 illustrates an example of a suitable computing and networking environment 500 into which the examples and implementations of any of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a system comprising, a reusable software wizard component, the reusable software wizard component including selectable user interface pages, one or more of which are selected for integration with one or more other wizard components to produce an integrated software wizard.

2. The system of claim 1 wherein the reusable software wizard component comprises an instance of a class that includes an interface and function for getting each of the selectable user interface pages.

3. The system of claim 1 wherein one of the wizard components comprises a page, and wherein the reusable software wizard component provides data for access by that page.

4. The system of claim 3 wherein the reusable software wizard component comprises an instance of a class that includes an interface and function for getting the data.

5. The system of claim 1 wherein one of the wizard components comprises data, which, in the integrated software wizard, pre-fills at least part of a user interface page selected from the reusable software wizard component.

6. The system of claim 1 wherein the reusable software wizard component includes a task for running in the integrated software wizard.

7. The system of claim 6 wherein the reusable software wizard component provides data, and includes means for the task and at least one page to have a dependency on the data.

8. The system of claim 1 wherein the reusable software wizard component includes logic that executes in the integrated software wizard.

9. The system of claim 1 wherein the reusable software wizard component includes logic that executes in the integrated software wizard.

10. The system of claim 1 wherein the integrated software wizard includes a summary page that provides information summarizing data and tasks corresponding to the integrated software wizard.

11. The system of claim 1 wherein the reusable software wizard component includes logic and tasks, the logic determining how pages of the reusable software wizard are related to data or tasks, or both data and tasks, of the reusable software wizard.

12. In a computing environment, a system comprising, a software wizard framework that integrates elements of a wizard with elements of a reusable software wizard component into an integrated wizard, the framework obtaining a first set of data and pages from the wizard, and invoking the reusable software wizard component to obtain a second set of data and pages, the framework integrating the first set of data and pages with the second set of data and pages, including by using at least some data from the first set to fill at least part of a page from the second set.

13. The system of claim 12 wherein the framework includes means for integrating any pages from the first set with any pages from the second set in any order to integrate the integrated wizard.

14. The system of claim 12 wherein the wizard includes a first set of tasks and the reusable software wizard component includes a second set of tasks, and wherein the framework includes means for integrating any tasks from the first set with any tasks from the second set in any order to integrate the integrated wizard.

15. The system of claim 12 wherein the wizard includes first logic and the reusable software wizard component includes second logic.

16. The system of claim 12 wherein the reusable software wizard component corresponds to a class.

17. The system of claim 12 wherein the reusable software wizard component includes logic and tasks, the logic determining how pages of the reusable software wizard are related to data or tasks, or both data and tasks, of the reusable software wizard.

18. One or more computer-readable media having computer-executable instructions, which when executed perform steps, comprising:
obtaining first data, a first page set comprising at least one page, and a first task set comprising at least one task from a set of information corresponding to a software wizard;
obtaining second data, a second page set comprising at least one page, and a second task set comprising at least one task from reusable software wizard component; and
integrating the first data and the second data, the first page set and the second page set, and the first task set and the second task set into an integrated wizard.

19. The one or more computer-readable media of claim 18 having further computer-executable instructions comprising, executing the tasks of the first task set and the tasks of the second task set.

20. The one or more computer-readable media of claim 18 wherein the reusable software wizard component corresponds to a class, and wherein obtaining the second data, the second page set and the second task set comprises invoking the reusable software wizard component and calling interfaces of the reusable software wizard component.
